(19) United States
(12) Patent Application Publication
(10) Pub. No.: US 2009/0150286 A1
(43) Pub. Date: Jun. 11, 2009

(54) POINT OF SALE AUTOMATIC SAVINGS PROGRAM CONTRIBUTION SYSTEM USING BIOMETRICS PAYMENT AND AUTHENTICATION WITH SMART CARDS, ELECTRONIC PAYMENT, AND WIRELESS MECHANISMS

(75) Inventor: Blain Barton, Hernando Beach, FL (US)

Correspondence Address: Blain Barton, 4399 3rd Isle Drive, Hernando Beach, FL, 34607, US

(73) Assignees: Blain Barton, Hernando Beach, FL (US); Mr. Edward Grau, West Palm Beach, FL (US)

(21) Appl. No.: 11/953,279

(22) Filed: Dec. 10, 2007

(51) Int. Cl. G06Q 40/00

(52) U.S. Cl. 705/44; 705/39

(57) ABSTRACT

The present invention relates to integrated financial network systems and more particularly pertains to a biometrics automatic method of automatically contributing monies by means of actual cash or electronic cash equivalents into an investment, savings, purchasing, payment, charity, loan, mortgage, insurance premium, or loyalty program upon making a purchase using biometrics for identification of the purchaser, identification of contribution preferences, and authentication. The invention includes a computer implemented method of processing a financial transaction executed by first person including identifying the person via biometric identification and verification methods, using biometric identification and financial transaction information to access user payment accounts, preferences for contribution, determining an automatic savings amount from the financial transaction by applying a contribution calculation, and contributing the calculated amount to an investment, savings, purchasing, payment, charity, loan, mortgage, insurance premium, or loyalty account. transactions, applying a pre-specified fixed dollar amount for each occurrence of a completed transaction, applying a pre-specified fixed dollar amount and total number of occurrences of a plurality of completed transactions, applying a percentage of a purchase amount of an individual pending transaction in the hands of a payment clearinghouse or payment instrument issuer, applying a pre-specified fixed dollar amount for each individual occurrence of a pending transaction in the hands of a payment clearinghouse or payment instrument issuer, applying a specified dollar amount for the transaction event, rounding up transactions to a higher amount increment, or rounding up plurality of completed transactions.

The purchase amount and contribution amount would be normally processed as individual transactions but can be combined.

The system further includes debiting the calculated savings amount from an account of the first person and crediting the savings amount to an account of a second person.

### FIELD OF THE INVENTION

The present invention relates to integrated financial network systems and more particularly pertains to a biometrics automatic method of automatically contributing monies by means of actual cash or electronic cash equivalents into an investment, savings, purchasing, payment, charity, loan, mortgage, insurance premium, or loyalty program upon making a purchase using biometrics for payment and identification of the purchaser, identification of contribution preferences, and authentication. The payment method includes, but is not limited to, biometric payment programs, debit and credit cards, smart cards, memory cards, cellular phone chips, stored value cards, electronic payment devices linked to an account, ACH payment, or monetary currency. Biometrics information includes, but is not limited to, iris eye recognition camera device, fingerprint recognition device, speech recognition device, human body “RF” identification chip reading device, a DNA reading device, or a combination thereof. Contributions can be submitted to accounts in either incremental or batched amounts.

Contribution calculation preferences set by the individual include, but are not limited to, applying a percentage of a purchase amount of an individual completed transaction, applying an aggregated purchase amount of a plurality of completed transactions, applying a pre-specified fixed dollar amount for each occurrence of a completed transaction, applying a pre-specified fixed dollar amount and total number of occurrences of a plurality of completed transactions, applying a percentage of a purchase amount of an individual pending transaction in the hands of a payment clearinghouse or payment instrument issuer, applying a pre-specified fixed dollar amount for each individual occurrence of a pending transaction in the hands of a payment clearinghouse or payment instrument issuer, applying a specified dollar amount for the transaction event, rounding up transactions to a higher amount increment, or rounding up plurality of completed transactions.

The invention includes a computer implemented system and method of reading a method of payment of an individual, processing a financial transaction executed by the individual, biometric devices for generating a biometrics identification signal for identifying the individual, and a computer implemented system and method for using biometric and payment information in determining an automatic contribution amount from pre-determined information applied to the occurrence or amount of a financial transaction. An investment, savings, purchasing, payment, charity, loan, mortgage, insurance premium, or loyalty program provider is connected to the service provider of the invention for receiving the signal representative of the contribution amount and processes the contribution in the name of the individual.

The purchase amount and contribution amount would be normally processed as individual transactions but can be combined.

### DESCRIPTION OF THE PRIOR ART

Integrated financial network systems heretofore devised and utilized are known to consist basically of familiar, expected and obvious structural configurations, notwithstanding the myriad of designs encompassed by the prior art, which have been developed for the fulfillment of countless objectives and requirements.

### KNOWN PRIOR ART

Known prior art includes U.S. Pat. No. 6,164,533 to Barton and U.S. Pat. No. 6,112,191 to Burke. Other prior art includes existing payment systems, payment accounts, payment networks, and various forms of biometric identification.

### BACKGROUND INFORMATION

Using biometric-based payment systems and biometric authentication with cards, smartcards, or electronic payment systems for automatic investment savings contribution system substantially improves upon the conventional concepts and designs of prior art as it leverages emerging payment methods, improved security measures, and teaches new and useful automation computer systems and computer implemented methods while allowing people to invest, save, and donate. The present invention provides a new point of sale (POS) automatic system and technology for contributing monies into an investment, savings, purchasing, payment, charity, loan, mortgage, insurance premium, or loyalty program contribution upon using a form of payment and applying pre-determined information to the occurrence or amount of a transaction. Examples of the various elements of the present invention are as follows:

### EXAMPLE #1

Bob makes a daily purchase with a biometrics purchase account by authenticating himself at a terminal using a biometrics fingerprint scan to complete the purchase. The invention uses biometric identification to identify Bob, determine Bob's payement account, Bob's preference to roundup his transaction, and contribute his roundup contribution to his principle account for his home loan. The invention software is designed to round all purchases to the nearest whole dollar, with the excess change going directly to the principle loan account. The invention can also use transaction percentages or other contribution calculation methods to direct funds into the card holder's principle loan account to pay off their existing home, car or boat loan. This authenticated biometrics saving program may be called Automatic Loan Principle Savings Program (ALPSP) and/or AutoMortgage.

### EXAMPLE #2

Page's parents are saving for her college education. Page's mother makes a purchase using her debit, credit or smartcard and she is authenticated using a PIN number and biometrics facial scan combination. Included on the card is biometrics and roundup program preference information designed in the software to round all purchases to the nearest whole dollar making checkbook and/or balances reconciliation easy. Deposits are then electronically transferred into her daughter's college education fund. This authenticated biometrics program may be called Auto College.

### EXAMPLE #3

Ed makes a daily purchase with his debit smartcard at a POS terminal and authenticates himself at a terminal using a biometrics RFID Human chip scan while makes the purchase. His biometrics information is linked to his savings account information and preferences for making automatic University Alumni or charity contribution deposits from deposits including e-currency and/or smart cards with e-pay, chip cards using point-of-sale transactions and authenticated users using biometrics authentication.. These preferences include the roundup program designed in the software to round all purchases to the nearest whole dollar making checkbook and/or balances reconciliation easy, while the excess change goes directly into their Alumni of choice. Lump sum percentages can also be applied in denominations (i.e. $5, $10, $15, $20), electronic credits, or points. This authenticated biometrics program may be called AutoAlumni.

### EXAMPLE #4

Blain, an employee, makes a daily purchase with his debit, credit or smartcard at a POS terminal and authenticates himself using a Personal Identification Number (PIN) and biometrics DNA recognition while making a purchase. The biometric information combined with the smartcard includes user preferences to use the roundup program designed in the invention to round all purchases to the nearest whole dollar making balances and reconciliation easy. Blain would make the contribution and his employer would then match the contributions he made while making everyday purchases through the original 401K program rules. 401K debit, credit and smartcards can be issued by banks or card issuers for businesses of any kind to be able to contribute to 401K savings and retirement plans for small business employees at any level. This 401K auto contributor authenticated biometrics program may be called Auto401K or AutoInvest.

### SUMMARY OF THE INVENTION

The present invention relates to integrated financial network systems and more particularly pertains to a biometrics automatic method of automatically contributing monies by means of actual cash or electronic cash equivalents into an investment, savings, purchasing, payment, charity, loan, mortgage, insurance premium, or loyalty program upon making a purchase using biometrics for identification of the purchaser, identification of contribution preferences, and authentication. The invention includes a computer implemented method of processing a financial transaction executed by first person including identifying the person via biometric identification and verification methods, using biometric identification and financial transaction information to access user payment accounts, preferences for contribution, determining an automatic savings amount from the financial transaction by applying a contribution calculation, and contributing the calculated amount to an investment, savings, purchasing, payment, charity, loan, mortgage, insurance premium, or loyalty account.

The purchase vehicle includes, but is not limited to, biometric payment programs, debit and credit cards, I.D. cards, memory cards, cellular phone chips, stored value cards, electronic payment devices linked to an account, ACH payment, or monetary currency. Biometrics information includes, but is not limited to, iris eye recognition camera device, fingerprint recognition device, speech recognition device, human body “RF” identification chip reading device, a Deoxyribonucleic Acid DNA reading device, a Recognition or Radio Frequency Identification (RFID) implantable tag chip, or a combination thereof. Identification may also be made in conjunction with a personal identification number (PIN) or code. Contributions can be submitted to accounts in either incremental or batched amounts.

Contribution calculation preferences set by the individual include, but are not limited to, applying a percentage of a purchase amount of an individual completed transaction, applying an aggregated purchase amount of a plurality of completed transactions, applying a pre-specified fixed dollar amount for each occurrence of a completed transaction, applying a pre-specified fixed dollar amount and total number of occurrences of a plurality of completed transactions, applying a percentage of a purchase amount of an individual pending transaction in the hands of a payment clearinghouse or payment instrument issuer, applying a pre-specified fixed dollar amount for each individual occurrence of a pending transaction in the hands of a payment clearinghouse or payment instrument issuer, applying a specified dollar amount for the transaction event, rounding up transactions to a higher amount increment, or rounding up plurality of completed transactions.

The purchase amount and contribution amount would be normally processed as individual transactions but can be combined.

The system further includes debiting the calculated savings amount from an account of the first person and crediting the savings amount to an account of a second person.

This technology is called POINT OF SALE AUTOMATIC SAVINGS PROGRAM CONTRIBUTION SYSTEM USING BIOMETRICS PAYMENT AND AUTHENTICATION WITH SMARTCARDS, ELECTRONIC PAYMENT, AND WIRELESS MECHANISMS.

Payment, Biometric identification, and security devices being used by the system include specific prior art. The program uses biometric identification, username, password and authentication, validation replacement, corporate domain logins, secure extranet usage and access, document signing via savings concepts including, but not limited to, web-based thin-client software processing financial transactions. Graphical interfaces can differ by licensed vendors. The automatic contribution savings program would include but not be limited to authentication and secure web access using secure-socket-layers (SSL), smart card based digital signatures, email encryption including 128-bit encryption, secure biometrics logon, XML software integration, file directory encryption for all financial records and real-time backup systems. Systems such as portable security and X509v3 certificate identification and storage records for investments are included. Technology will encompass smart card authentication technology including, public key infrastructure, Certificates, Active Directory, Group Policies, Smart cards and readers, Smart Card Software and Management Policy.

Smart card authentication processes would include protocols such as WinLogon service, Kerberos, Smart Card CSP, Crypto API, Smart Card Driver, Key Distribution Center (KDC), and Active Directory and other industry standards. Smart cards would be capable of communication with all different type form factors including computing devices such as hand-held devices, wireless hand-held phones and tablet PC mobile devices by making contributions made through a smart card terminal and reader. Equipment would include smart card readers that may follow ISO 7816-3 PC/SC Compliancy or greater, cards may use DES/Triple DES and MAC security capabilities and on cards and chips with loaded 8K, 16K, 5 MB, 1 GB, 2 GB, 4 GB or greater for user data. Information and applications on a smartcards and/or memory chip cards, debit or credit method of payment cards, coupons cards, telephone cards, and coin sorter/collectors with paper currency feeders.

The present invention improves upon prior art in that it teaches technology and methods that include a new and innovative biometric contribution system for individuals to automatically and securely contribute to an investment, savings, purchasing, payment, charity, loan, mortgage, insurance premium, or loyalty account. The invention allows a contribution system to be defined by an individual and stored along with the biometric information of the individual. Payment instruments, payment accounts, and savings instruments can be updated without having to issue new cards and can perform be quick and exact recognition of the card holder by biometric identification in conjunction with or without a specified personal identification number (PIN) used in authenticating and automating a payment transaction combined with savings contributions.

The pre-determined information of the individual would include biometric characteristics unique to the individual, savings and payment information, contribution calculation preferences, and investment, savings, purchasing, payment, charity, loan, mortgage, insurance premium, or loyalty account information. This, in conjunction with a specified personal identification number (PIN) used in authenticating and automating a payment transaction, is combined with investment or savings contribution directed into a specified investment savings program account and includes username, password and authentication, validation replacement, corporate domain logins, secure extranet usage and access, document signing via savings concepts including, but not limited to, web-based thick-winform “click once” deployment software or custom online banking module. Graphical interfaces can differ by licensed vendors. The automatic contribution savings program could include, but not be limited to, authentication and secure web access protocols using secure-socket-layers (SSL), smart card based digital signatures, email encryption, secure biometrics logon, XML software integration, file directory encryption for all financial records and real-time backup systems. Systems include portable security and certificate identification and storage records for investments.

All Suppliers from Electronic Fund Transfer Point of Sale (EftPOS) Terminals, Third Party Processors, Acquiring and Issuing Banks, and smartcard manufacturers jointly set up International Standard on how sales and cash advance transactions are formatted from the EftPOS terminals to the Issuing Banks (including Third Party Processors and Acquiring Banks). This smartcard structure is covered in the already existing International Standards Organization ISO8583, which is outside of this patent.

Note that all Base-24 fields are transmitted in display format (i.e. all Binary fields are converted to display for messaging) to avoid complications and provide standard message protocol such as ASCII-EBCDIC conversion and communications transparency. This results in binary fields (such as the primary bit map of 64 bits) being longer than the 8 bytes defined in the ISO8583 standard.

The invention follows this standard and does not modify its structure, fields, or rules defined. For instance, the amount field will not change for the transaction function stays as is. However, the contribution: either percentage of amount, rounding up function, dollar amount per transaction, or other calculation method, are submitted into additional fields, as instructed by ISO.

This allows the purchase amount to be authorized and settled as an individual transaction equal to the price of goods purchased. An additional amount equal to the contribution can be administered separate to the purchase transaction. However, the parameters to do the contribution and all required technology of the current invention shall use the ISO protocol. These amounts can also be combined as a single transaction.

Payment methods may also contain GPS identification and payment technology such as GPS Card Finder™ (GCF) to find and locate the smartcards' position. GPS technology is integrated into the smartcard chip design, which acts as a responder and can be remotely turned on to locate its' position. The card can then be remotely turned off, wiped or erased to ensure cardholders protection and security. This “anti-identity theft” mechanism assists law enforcement with finding missing cards and the person/people in possession of stolen credit and debit cards.

Payment methods may also contain transmission or wireless capability, such as Bluetooth™ or mobile phone technology to identify the payment method wirelessly.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is understood that the invention is not limited in its application to the details of construction and to the arrangements of the components set forth in the following description or illustrated in the drawings. The invention is capable of other embodiments and of being practiced and carried out in various ways including the use of biometrics. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is therefore an object of the present invention to provide a new biometrics point of sale automatic investment savings program contribution system apparatus and method which has many of the advantages of the integrated financial network systems mentioned heretofore and many novel features that result in a new deposit automatic savings contribution system machine which is not anticipated, rendered obvious, suggested, or even implied by any of the prior art integrated financial network systems, either alone or in any combination thereof.

It is another object of the present invention to provide a biometrics point of sale automatic savings program contribution system, which may be easily and efficiently manufactured and marketed.

It is a further object of the present invention to provide a human biometrics point of sale automatic savings program contribution system, which is of a durable and reliable construction.

An even further object of the present invention is to provide a human biometrics contribution system which is susceptible of a low cost of manufacture with regard to both materials and labor, and which accordingly is then susceptible of low prices of sale to the consuming public, thereby making such point of sale automatic investment savings program contribution system economically available to the buying public.

Still yet another object of the present invention is to provide a human biometrics automatic savings program contribution system which provides in the apparatuses and methods of the prior art some of the advantages thereof, while simultaneously overcoming some of the disadvantages normally associated therewith.

These together with other embodiments of the invention, along with the various features which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

### BRIEF DESCRIPTION OF THE DRAWINGS

FIG. 1 is an overview diagram of a system in accordance with one embodiment of the present invention.

FIG. 2 is a flow diagram of the functionality performed by a server in accordance with one embodiment of the present invention and the biometrics that are being used for identification and authentication of an individual as part of the automatic savings program.

FIG. 3 is a flow diagram of the functionality performed by a server in accordance with one embodiment of the present invention to daily process the automatic savings transaction using biometrics identification and authentication mechanisms.

FIG. 4 is a flow diagram of the functionality performed by a server in accordance with one embodiment of the present invention to perform a daily posting of the automatic savings transaction using biometrics identification and authentication mechanisms.

### DETAILED DESCRIPTION OF THE DRAWINGS

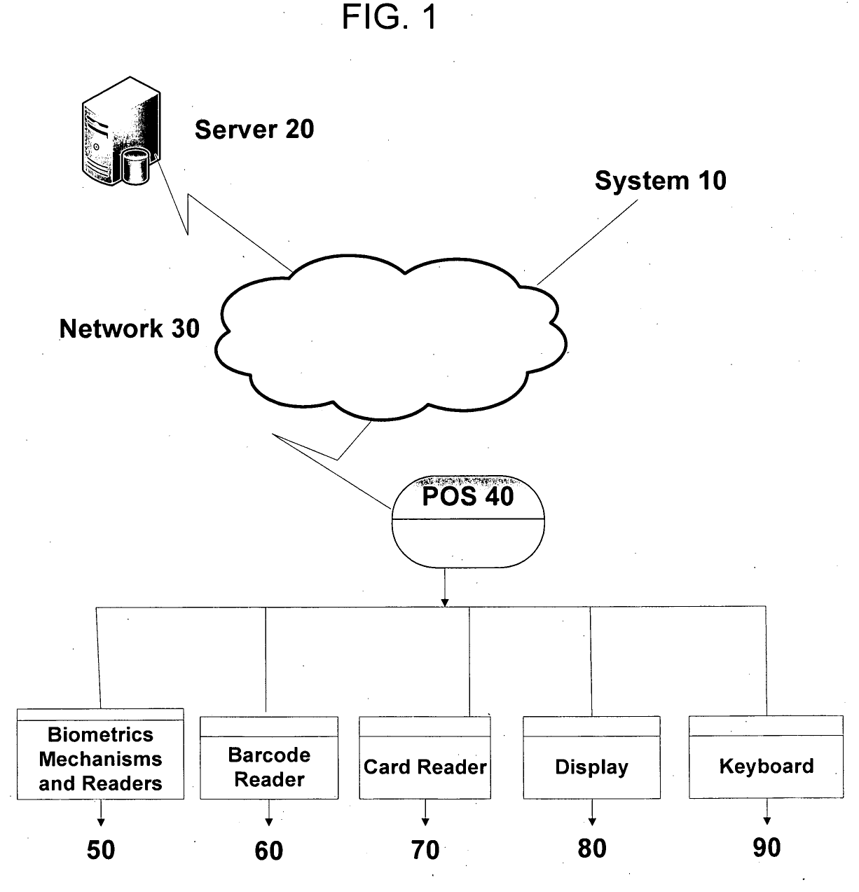

FIG. 1 is an overview diagram of a System 10 in accordance with one embodiment of the present invention. System 10 includes a point of sale device (“POS”) 40 coupled to a computer server 20 via an integrated financial Network 30. POS 40 is an electronic point of purchase register that includes a Scanner 60 that is used to read barcodes on products and to automatically enter the products and prices into POS 40. POS 40 further includes a Monetary Input Device 70 that reads account information from biometric payment programs, debit and credit cards, smart cards, memory cards, cellular phone chips, stored value cards, electronic payment devices linked to an account, ACH payment, or any other type of payment device that can be used to purchase an item. Biometric Receptor and Mechanisms 50, authenticates the cardholder to ensure security and authorization and identifies accounts, individual savings program preferences, and contribution preferences. POS 40 may include other devices, such as Biometric Receptor and Mechinisms 50, Monetary Input Device 70, Display 80, Keypad 90 that can be use to read account information for facilitating a transaction. In one embodiment, POS 40 is located at a retailer.

Network 30 can be any type of integrated financial network or communication device that allows POS 40 to communicate with Server 20. Network 30 includes one or more routers or computer systems. In one embodiment, Network 30 includes a computer system operated by a payment processor or service provider used at POS 40.

Server 20 is a computer system operated by a savings program provider such as a bank or other financial institution that is implementing an embodiment of the present invention. Server 20 may be any type of computer or other device that is capable of communicating with Network 30 and Biometric Mechanisms 50 executing software steps. In one embodiment, Server 20 includes a processor, memory and communication interface.

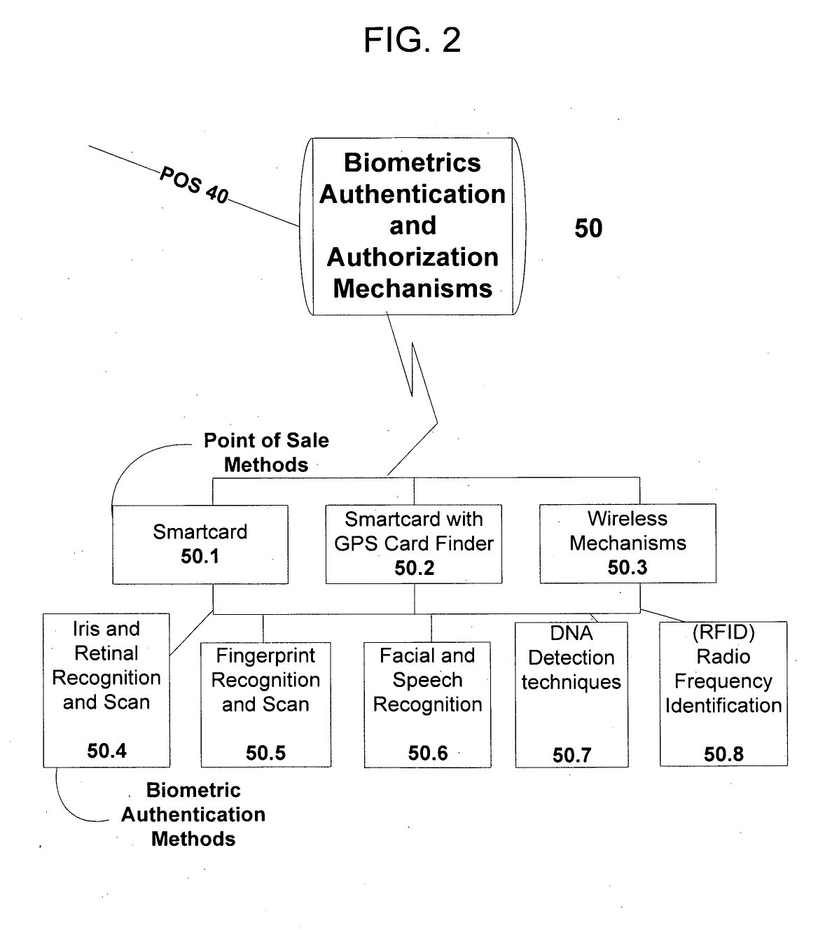

FIG. 2 is a flow diagram of the functionality performed by Server 20 in accordance with biometrics payment and authentication standards that are integrated and coded within the software and are used to operate the Biometric Receptor and Mechanisms 50. In other embodiments, the functionality can be performed by hardware, or any combination of hardware and software.

These biometrics methods use point-of-sale (POS) devices such as, but not limited to:

50.1—A smart card, chip card, or integrated circuit(s) card (ICC) is defined as any pocket-sized card with embedded integrated circuits which can process information. This implies that it can receive input which is processed—by way of the ICC applications—and delivered as an output. These include memory cards containing non-volatile memory storage components, and perhaps some specific security logic and microprocessor cards containing volatile memory and microprocessor components

50.2—Smartcard with GPS payment processing capability such as GPS Card Finder™—A smart card, chip card, or integrated circuit(s) card (ICC) 50.2, is defined as any pocket-sized card with embedded integrated circuits which can process information. This implies that it can receive input which is processed—by way of the ICC applications—and delivered as an output. There are two broad categories of ICCs. Memory cards containing non-volatile memory storage components, and perhaps some specific security logic and microprocessor cards containing volatile memory and microprocessor components. The smartcard may also contain GPS technology such as GPS Card Finder™ to find and locate the smartcards' position. GPS technology is integrated into the smartcard chip and is a responder that can be remotely turned on to locate its' position. The card can then be remotely turned off, wiped or erased to ensure the card holders protection and security. This anti-identity theft mechanism and assists law enforcement with finding missing cards and the person/people in possession of stolen credit and debit cards.

50.3—Wireless Mechanisms 50.3—includes any type of electrical or electronic operation which is accomplished without the use of a “hard wired” connection. Wireless mechanisms refer to telecommunications systems (e.g., radio transmitters and receivers, remote controls, computer networks, network terminals, etc.) which use some form of energy (e.g.,radio frequency (RF), infrared light, laser light, visible light, acoustic energy, etc.) to transfer information without the use of wires. Information is transferred in this manner over both short and long distances.

Using biometric mechanisms such as, but not limited to:

50.4—Iris and Retinal Recognition and Scan—The iris of the eye possess physical patterns unique to each person. Iris-scan biometric systems would analyze several points of the iris, including rings, furrows and freckles. Retinal scanning systems look at the pattern of blood vessels at the back of the eye. Retina scans use a light to shine on the retina, and require that the person place their eye close to the scanner, remain still, and focus on a specified location. Biometric retina recognition systems are among the most accurate of all biometric technologies and as such are used for high security applications.

50.5—Fingerprint Recognition and Scan—Modern fingerprint identification systems take digital scans of a person's fingertips and records and its unique physical characteristics, such as whorls, arches, loops, ridges and furrows. Fingerprint data is either stored as an image or encoded as a character string.

50.6—Facial and Speech Recognition—Biometric facial recognition would measure and analyze the physical attributes of a person's face. Characteristics measured include the overall structure and shape of the face, and distances between the eyes, nose, mouth, and jaw edges. Speech recognition would be used to render and identify the person speaking.

50.7—DNA Detection Techniques—molecular detection techniques would assess deoxyribonucleic acid (DNA) and match the nucleic acid to its source to identify an individual. DNA recognition instruments would allow rapid identification of the origin of DNA in an environmental or medical sample. DNA recognition instruments would utilize nucleic acid hybridization and the polymerase chain reaction (PCR).

50.8—(RFID) Radio Frequency Identification—A micro implant with a radio frequency identification (RFID) implantable tag, injected into fatty tissue of the individual would be used for identification and authorization.

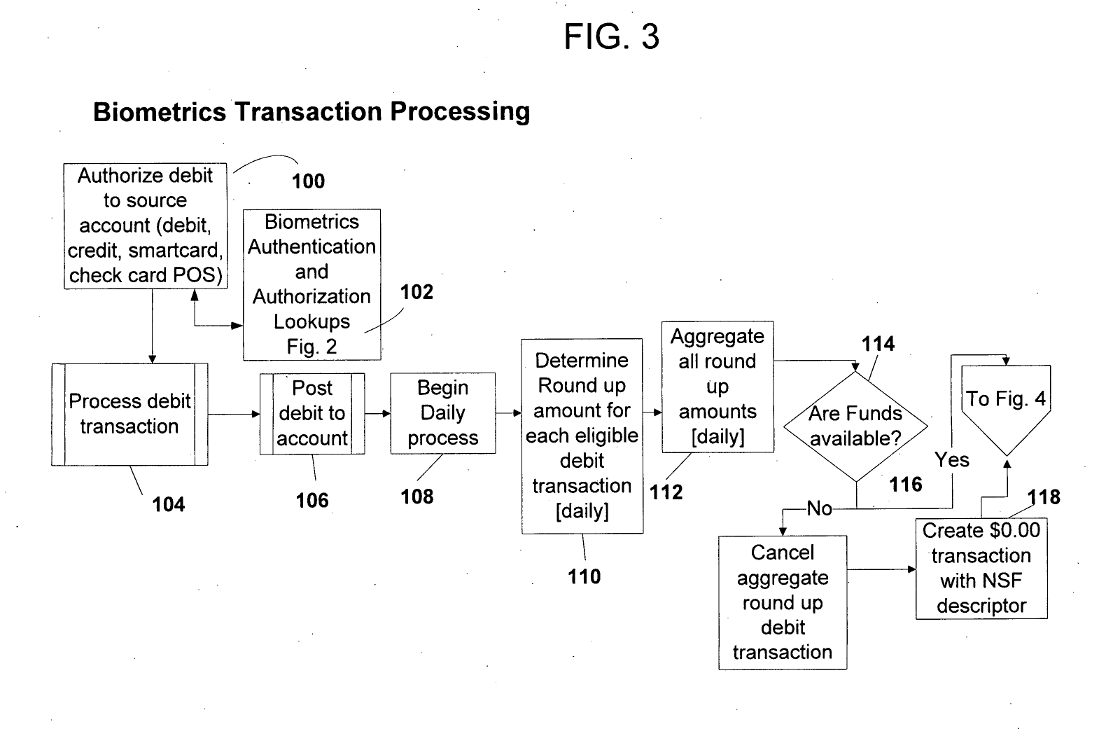

FIG. 3 is a flow diagram of the functionality performed by server 20 in accordance with one embodiment of the present invention to processing the automatic savings transaction using biometrics payment and authentication.

100: The form of payment (e.g., check card POS, check, etc.) selected at 102 is received from Network 30 and identified.

101: Biometrics payment and authentication and/or authorization using Iris and Retinal Recognition, Fingerprint Recognition and Scan, Facial and Speech Recognition. DNA match reader, and Radio Frequency Identification (RFID) is received from Network 30.

102: The biometric and/or payment information of the transaction is compared to pre-determined information of the individual. The invention authenticates the individual and initiates the contribution preferences of the individual accessing pre-determined information 103 in the process.

103: Pre-determined information of the individual is stored including biometric characteristics unique to the individual, savings and payment information, contribution calculation preferences, and investment, savings, purchasing, payment, charity, loan, mortgage, insurance premium, or loyalty account information.

104: The purchase transaction, such as a purchase at POS 40 using a debit card, is processed.

105: The purchase transaction is posted to the source account

106: The purchase transaction settles back to a merchant where the purchase originated.

108: The savings program contribution transaction begins.

110: The contribution preferences provided in step 102 determines the contribution amount calculation method (such as a round up amount) for each eligible transaction. For example, the account information indicated rounding was the preferred contribution calculation method and a POS purchase of $0.75 would roundup by $0.25 for a total amount of $1.00. This occurs on a real time, daily, or periodic batch basis.

112: All round up amounts may be aggregated. By aggregating the roundup contributions in batch postings, overdrafts to the source account can be avoided. In one embodiment, the daily posting occurs at the end of the day to further avoid overdrafts.

114: A determination is made if funds are available in the source account. If not, the aggregated round up debit transaction is cancelled (116) and a $0.00 transaction is created with a no funds in source account descriptor (118).

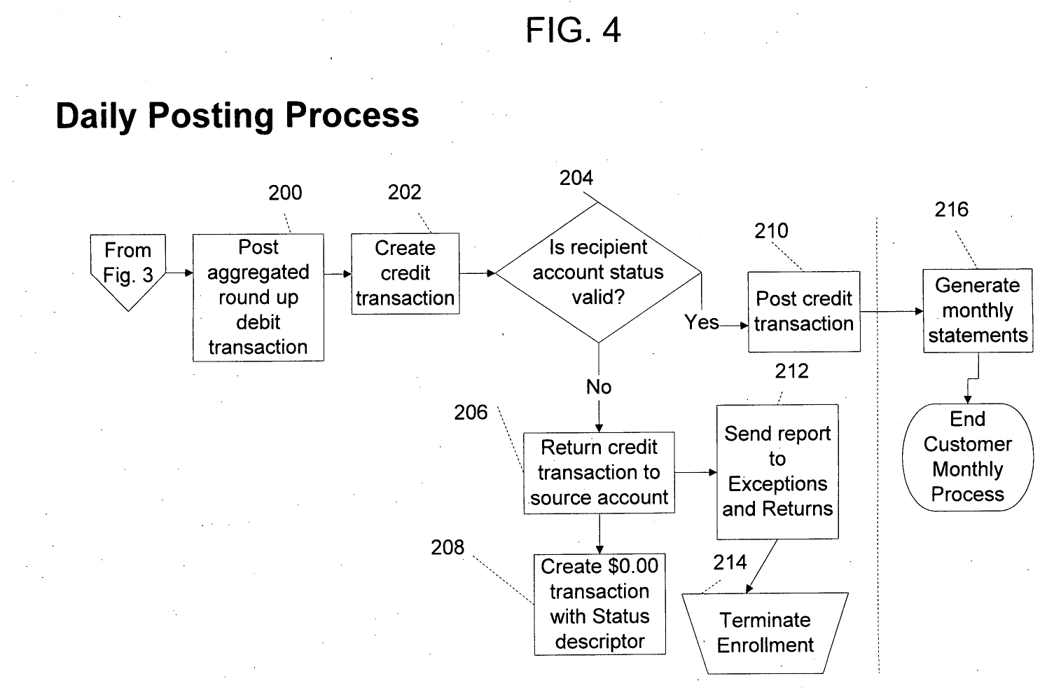

FIG. 4 is a flow diagram of the functionality performed by server 16 in accordance with one embodiment of the present invention to perform the posting of the contribution amount.

200: If funds are determined to be available at 114, the aggregated contribution amount is posted as a contribution transaction.

202: The contribution transaction is created.

204: A determination is made if the savings account of the individual is valid. If it is valid, the contribution transaction is posted (210).

206: If the recipient account(s) is not valid at 204, the contribution transaction is returned to the source account and a $0.00 transaction is created with a status descriptor (208). A report of the invalid source account is sent to an “exceptions & returns” file and enrollment of the automatic savings account for that customer is terminated (212, 214).

216: Monthly statements are generated that include the automatic savings function. Both the source and recipient accounts may display a month-to-date and year-to-date summary of contribution transactions on the statement of the individual.

I claim:

1. A computer system for automatically contributing monies to a savings program upon using a form of payment to make a deposit comprising:
a biometrics receptor for identifying any biometric characteristics of an individual;
a monetary input device for reading the form of payment;
an identification input device for identifying any account information of the individual from the biometric characteristics or the form of payment;
a point of purchase register connected to a scanner for subtotaling a plurality of entities for purchase, calculating any purchase fees and taxes, and calculating a total purchase amount,
an input device with a display and a keypad positioned at the point of purchase and connected to the point of purchase register for receiving information from the monetary input device, wherein the monetary input device is adapted to receive a payment amount, a deposit amount, a paper currency amount, and a coupon amount;
an integrated financial network service provider connected to the monetary input device and the biometrics receptor for receiving biometric characteristics, the total purchase amount, the coupon amount, the deposit amount, the paper currency amount, the coupon amount, and the form of payment;
a form of payment provider connected to the integrated financial network service provider for receiving the biometric characteristics, the total purchase amount, the coupon amount, the deposit amount, the paper currency amount, the coupon amount, the form of payment, and a plurality of payment information;
a saving program provider connected to the integrated financial network service provider for receiving the biometric characteristics, the payment information, the total purchase amount, and the deposit amount, and a system for using the biometric characteristics and the payment information to identify the individual, access a plurality of pre-determined information of the individual including any contribution preferences, any accounts, and any savings program, and calculating a contribution amount based on the pre-determined information;
a service provider connected to the saving program provider for receiving a signal and instructions for processing the contribution amount from a savings account of the individual; and
The savings program provider further connected to the service provider for receiving the contribution amount and the savings program information to contribute the contribution amount to the savings program of the individual.

2. A computer system as set forth in claim 1 wherein the biometrics receptor includes, but is not limited to, Iris and Retinal Recognition, Fingerprint Recognition and Scan, Facial and Speech Recognition, DNA Reading Device, and (RFID) Radio Frequency Identification.

3. A computer system as set forth in claim 1, wherein calculating the contribution amount includes, but is not limited to, applying a percentage of a purchase amount of an single completed transaction, applying an aggregated purchase amount of a plurality of completed transactions, applying a pre-specified fixed dollar amount for each occurrence of a completed transaction, applying a pre-specified fixed dollar amount and total number of occurrences of a plurality of completed transactions, applying a specified dollar amount for a purchase transaction event, rounding up a transaction to a higher amount increment, or rounding up a plurality of completed transactions to a higher amount increment.

4. A computer system as set forth in claim 1, further comprising: determining if adequate funds are available in the savings account of the individual before deducting the contribution amount.

5. A computer system as set forth in claim 1 wherein the savings program includes a plurality of investment, savings, purchasing, payment, charity, insurance premium, loan, mortgage, or loyalty programs.

6. A computer system as set forth in claim 1, wherein the accounts of the individual include a plurality of savings, biometric payment programs, electronic credit, electronic savings, investment, loan, mortgage, insurance, brokerage, trust, charity, loyalty program, mortgage, loan, or accounts in the name of a separate individual.

7. A method of automatic savings comprising using biometrics identification and authentication comprising: executing a financial transaction for a first account; identifying biometric characteristics of an individual owner of the first account, determining an identity of the individual using biometric characteristics and the financial transaction, accessing a plurality of pre-determined savings preferences and account information based on the identity of the individual, calculating a contribution amount based on a mathematical calculation applied to the financial transaction; deducting the contribution amount from the first account; and crediting the contribution amount to a second account.

8. The method of claim 7, wherein the contribution amount is calculated based on, but not limited to, applying a percentage of a purchase amount of an single completed transaction, applying an aggregated purchase amount of a plurality of completed transactions, applying a pre-specified fixed dollar amount for each occurrence of a completed transaction, applying a pre-specified fixed dollar amount and total number of occurrences of a plurality of completed transactions, applying a specified dollar amount for a purchase transaction event, rounding up a transaction to a higher amount increment, or rounding up a plurality of completed transactions to a higher amount increment.

9. The method of claim 7, further comprising: determining if adequate funds are available in the first account before debiting the contribution amount.

10. The method of claim 7, wherein the first account, the second account, and the third account include a plurality of savings, biometric payment program, electronic credit, electronic savings, investment, insurance, brokerage, trust, charity, loyalty program, mortgage, loan, or accounts in the name of a separate individual.

11. The method of claim 7 wherein a portion of the contribution amount from the first account credited to the second account and a remaining portion of the contribution amount is credited to a third account.

12. A computer system as set forth in claim 1, wherein the predetermined information of the individual includes a plurality of instructions and rules for apportioning the contribution amount between accounts and computer readable program code for receiving and executing the instructions and rules for apportioning the contribution amount.

13. A computer system as set forth in claim 1 wherein the form of payment includes biometric payment programs, debit and credit cards, I.D. cards, memory cards, cellular phone chips, stored value cards, electronic payment devices linked to an account, ACH payment, or monetary currency.

14. A computer system as set forth in claim 1 wherein the purchase amount and the payment amount are processed together as one transaction.
